(19) United States
(12) Patent Application Publication
(10) Pub. No.: US 2024/0421755 A1
(43) Pub. Date: Dec. 19, 2024

(54) APPARATUS FOR MOUNTING A SOLAR PANEL ON A VEHICLE

(71) Applicant: Roboteos Inc., Costa Mesa, CA (US)

(72) Inventors: Thomas Gacka, Costa Mesa, CA (US); Masoud Vaezi, Huntington Beach, CA (US)

(21) Appl. No.: 18/740,855

(22) Filed: Jun. 12, 2024

Related U.S. Application Data
(60) Provisional application No. 63/507,906, filed on Jun. 13, 2023.

(51) Int. Cl. H02S 20/32; B60R 11/00; H02S 10/40; H02S 30/10

(52) U.S. Cl. CPC H02S 20/32; B60R 11/00; H02S 10/40; H02S 30/10; B60R 2011/004; B60R 2011/0089

(57) ABSTRACT

A device for mounting a solar panel to a vehicle includes a base frame, and a plurality of actuators pivotally coupled to the base frame and pivotable about respective pivot axes. Each actuator is transitional between a retracted position and an extended position. The device additionally includes a hub coupled to the actuators respective spherical joints. The spherical joints are configured to allow the hub to move relative to the actuators about two axes. A panel support frame is coupled to the hub and is configured to be engageable with a solar panel. The panel support frame is selectively positionable relative to the base frame via selective positioning of the actuators between their respective retracted and extended positions, and via selective pivoting of the actuators relative to the base frame.

### CROSS-REFERENCE TO RELATED APPLICATIONS

This application claims the benefit of U.S. Application Ser. No. 63/507,906, filed Jun. 13, 2023, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a solar panel mounting device, and more specifically, a device for mounting a solar panel to a vehicle and optimizing the position of the solar panel relative to the position of the sun.

### 2. Description of the Related Art

Solar panels are commonly used in a variety of different applications to convert solar energy into usable electricity. One of the key factors impacting the efficiency of solar panel energy production is the angle at which the solar panel is oriented relative to the sun. Solar panels that are oriented perpendicular to the sun tend to be more efficient than the same solar panel oriented in a non-perpendicular position.

It is common for solar panels to be mounted to the roof of mobile vehicles (campervans, RVs, boats, EV vans, e-trailers, etc.) as a common source of energy for appliances used in these vehicles. However, the energy production of such solar panels tends to be limited due to the incident angle of solar arrays on the panel as the sun moves at different zenith and azimuth angles relative to the panel.

Solar tracking systems have been developed which track the sun and alter the position of the solar panel based on the changed position of the sun. Commercial solar power plants frequently employ solar tracking systems, and are typically mounted at a large height off the ground, and take advantage of the array having a fixed mounting orientation and location with respect to the earth.

However, there are challenges in implementing solar tracking technology for use on vehicles. In particular, a mobile solar panel deployment may require that the solar panels be mounted flat while moving to avoid a large increase in the height taken up by the panels, and also to avoid large aerodynamic forces. A mobile implementation may further require actuation of large zenith angles across 360 degrees of local azimuth angles, as the vehicle body reference frame can be at any orientation and location with respect to the earth.

Accordingly, there is a need in the art for a device for mounting solar panels to a vehicle, which allows for optimization of the solar energy receivable from the sun. Various aspects of the present disclosure address this particular need, as will be discussed in more detail below.

### BRIEF SUMMARY

In accordance with one embodiment of the present disclosure, there is provided a device including a novel 2-axis 3RPS (revolute prismatic spherical) robotic platform configured to support a solar panel(s). The platform is capable of mounting the solar panel(s) with minimal height increase of a flat panel installation when in a stowed position. The platform is further capable of being selectively deployed to actuate greater than 30 degrees of panel zenith angle across 360 degrees of local azimuth when deployed, which may facilitate delivery of up to 2.5 times the energy of a fixed flat panel array. The device may include a GPS (global positioning system) sensor/chip/circuit/resource and an IMU (inertial measurement unit) sensor/chip/circuit/resource to determine the location and orientation of the vehicle, as well as associated electronics (e.g., processors, memory, etc.) to facilitate solar positioning calculations, actuator controls, fault diagnostics, and user interface functionalities.

One implementation of the device includes a base frame, and a first actuator pivotally coupled to the base frame and being transitional relative to the base frame about a first pivot axis between a first retracted position and a first extended position. A second actuator is also pivotally coupled to the base frame and is transitional relative to the base frame about a second pivot axis between a second retracted position and a second extended position. The second pivot axis is angularly offset from the first pivot axis. A third actuator is pivotally coupled to the base frame and is transitional relative to the base frame about a third pivot axis between a third retracted position and a third extended position. The third pivot axis is angularly offset from the first and second pivot axes. A first spherical joint is coupled to the first actuator, a second spherical joint is coupled to the second actuator, and a third spherical joint is coupled to the third actuator. A hub is coupled to the first actuator via the first spherical joint, with the hub being coupled to the second actuator via the second spherical joint, and the hub being coupled to the third actuator by the third spherical joint. The hub is connectable to a solar panel. Each of the first spherical joint, the second spherical joint and the third spherical joint are configured to allow the hub to move relative to the base frame about two axes. The hub is selectively positionable relative to the base frame via selective positioning of the first actuator, the second actuator, and the third actuator between their respective retracted and extended positions, and via selective pivoting of the first, second and third actuators relative to the base frame.

The device may additionally include a panel support frame coupled to the hub and configured to facilitate connection between the solar panel and the hub.

Each of the first actuator, second actuator, and third actuator may include an extendable portion and a support portion. The extendable portion may be moveable relative to the support portion between the respective extended position and retracted position. The extendable portion may include a distal end that is moved away from the respective one of the first, second, and third pivot axes as the corresponding actuator moves from the respective retracted position toward the extended position. Each extendable portion may include an extender arm and each support portion may include a pair of lateral supports on opposite sides of the extender arm. Each extender arm may include an upper rail and a lower rail, with the upper rail being translatable relative to the lower rail in response to transition of the extendable portion between the extended position and the retracted position. Each support portion may be coupled to the lower rail.

The first, second, and third actuators may be evenly spaced about a central axis.

The device may additionally include a first actuator sensor for sensing the position of the first actuator being in the first retracted position and the first extended position.

The device may additionally include a controller in communication with the first, second, and third actuators. The controller may be configured to receive position information associated with the solar panel and facilitate movement of the first, second, and third actuators to transition the solar panel from a current position toward a desired position. The controller may be configured to facilitate movement of the solar panel from the current position toward the desired position autonomously in response to receipt of the position information.

The movement of the actuators between their respective retracted and extended positions may allow for selective adjustment of the center position height of the hub relative to the base frame.

The device may also include a first actuator sensor for sensing the position of the first actuator between the first retracted position and the first extended position, a second actuator sensor for sensing the position of the second actuator between the second retracted position and the second extended position, and a third actuator sensor for sensing the position of the third actuator between the third retracted position and the third extended position.

According to another embodiment, there is provided a method of selectively positioning a solar panel configured to be attachable to a vehicle. The method includes receiving position data associated with the solar panel. The solar panel is coupled to a first actuator, a second actuator, and a third actuator, with each actuator being pivotally coupled to a base, and each actuator having an extendable arm. The method further includes calculating an optimal position of the solar panel based on the received position data, and facilitating transition of the solar panel from a current position toward the optimal position via selective pivotal movement of at least one of the first, second, and third actuators, and movement of at least one extendable arm of the first, second, and third actuators.

The calculating and facilitating steps may proceed autonomously in response to receipt of the position data.

The method may also include the step of receiving a command signal from the user, with the receiving step proceeding in response to receipt of the command signal.

The method may additionally comprise the step of receiving updated position information a prescribed period of time after transition of the solar panel from the current position toward the optimal position. The method may include the step of calculating an updated optimal position based on the updated position information. The method may also comprise the step of facilitating transition of the solar panel from the optimal position toward the updated optimal position via selective pivotal movement of at least one of the first, second and third actuators, and movement of at least one extendable arm of the first, second, and third actuators.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an isometric view of one embodiment of a device for mounting a solar panel to a vehicle, with the device being shown in a deployed configuration;

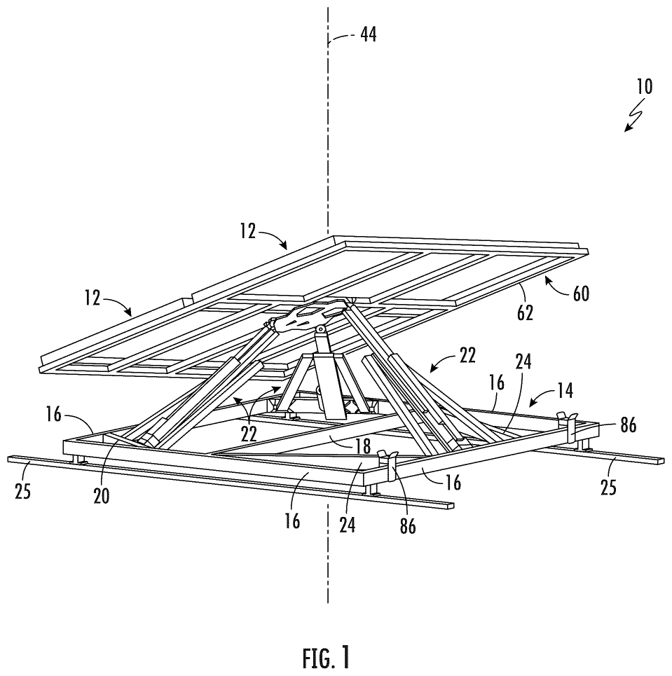

FIG. 2 is a front view of the device depicted in FIG. 1;

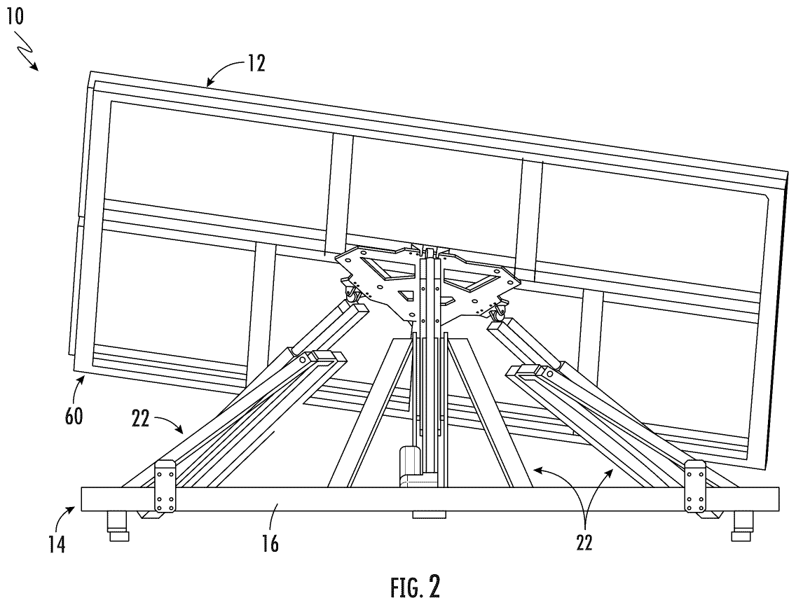

FIG. 3 is a side view of the device depicted in FIG. 1;

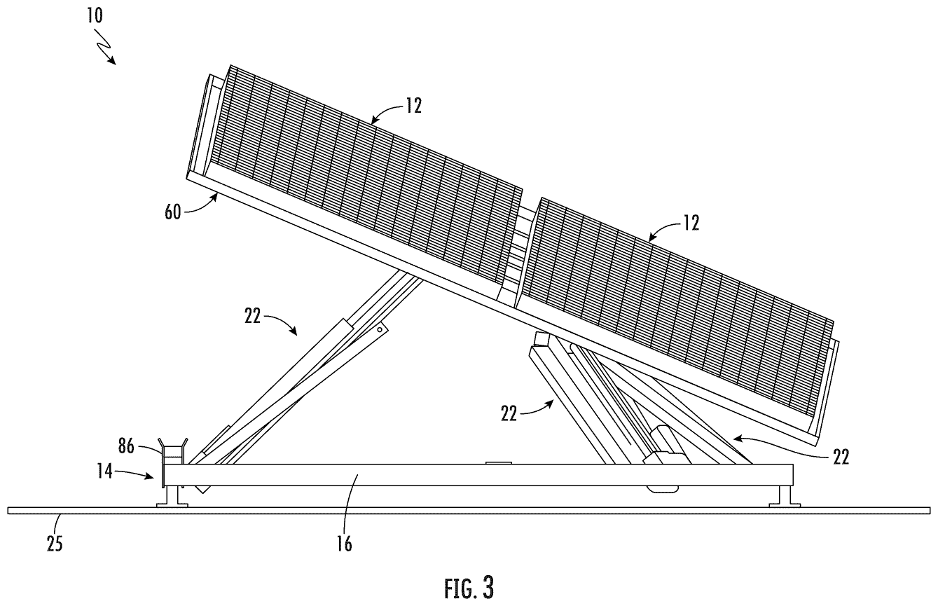

FIG. 4 is a bottom view of the device depicted in FIG. 1;

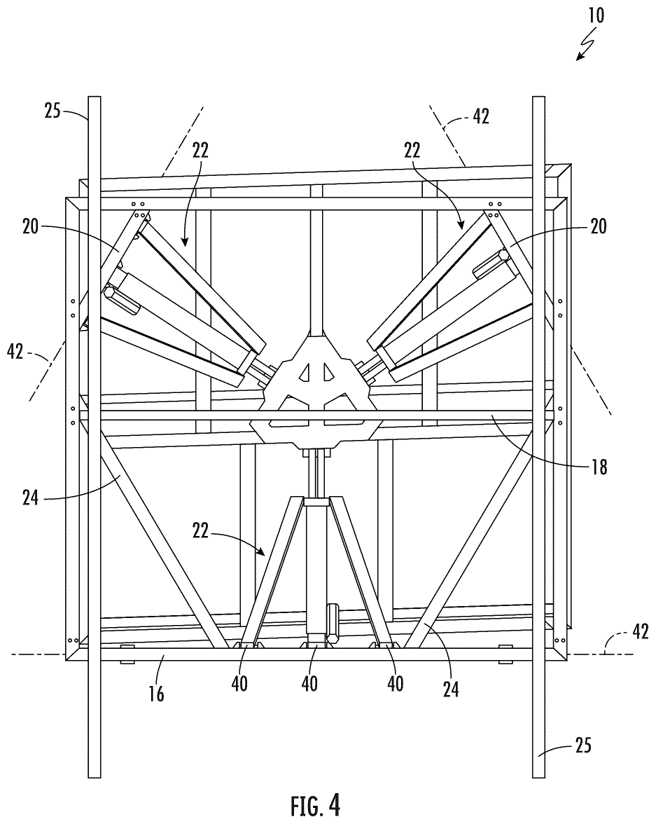

FIG. 5 is a side view of the device having been transitioned to a particular deployed configuration which places the panels in raised, parallel position relative to an underlying base frame;

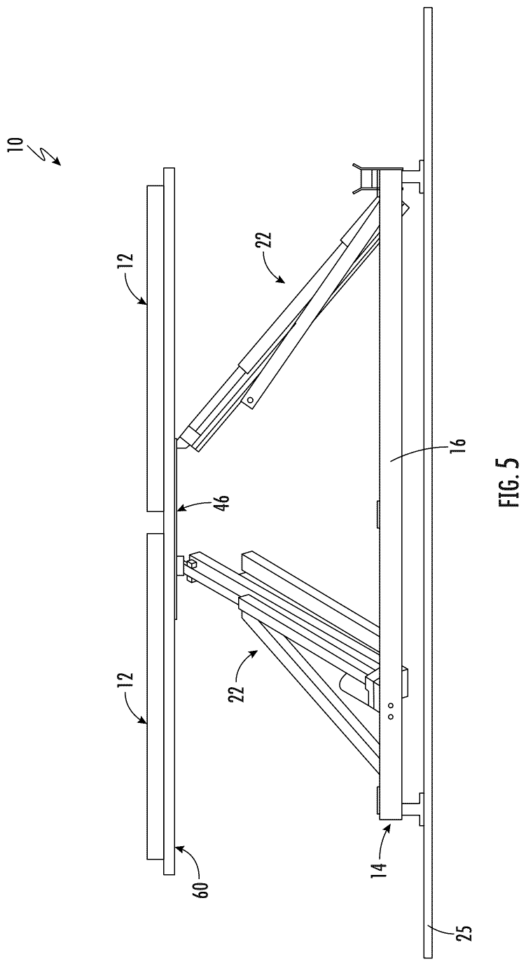

FIG. 6 is a bottom view of the device transitioned in a home (lowered) configuration;

FIG. 7 is a side view of the device depicted in FIG. 6;

FIG. 8 is an upper perspective view of the device, with the solar panels and panel support frame having been removed to more clearly illustrate a hub plate and actuators;

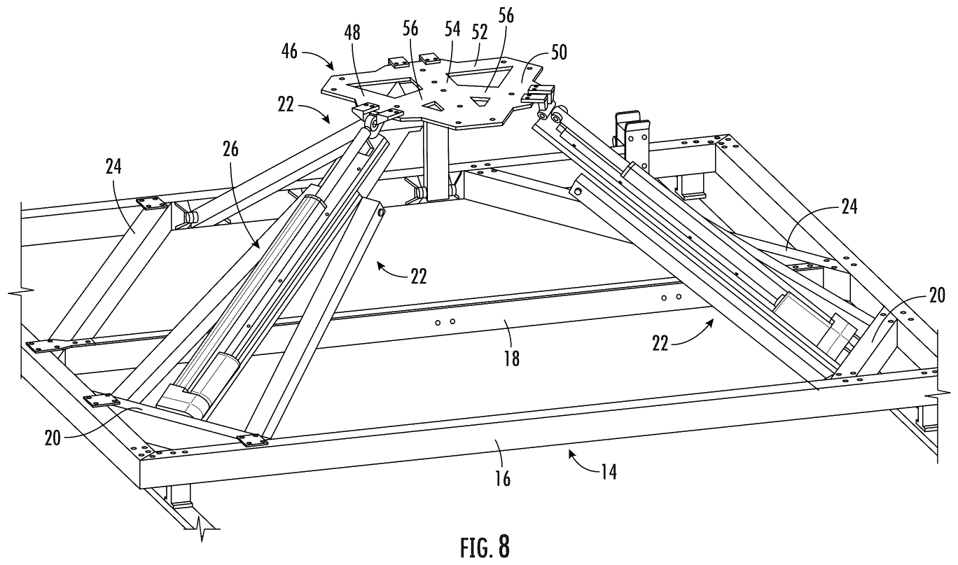

FIG. 9 is an enlarged view to illustrate an actuator and the interconnection to the base frame and the hub plate;

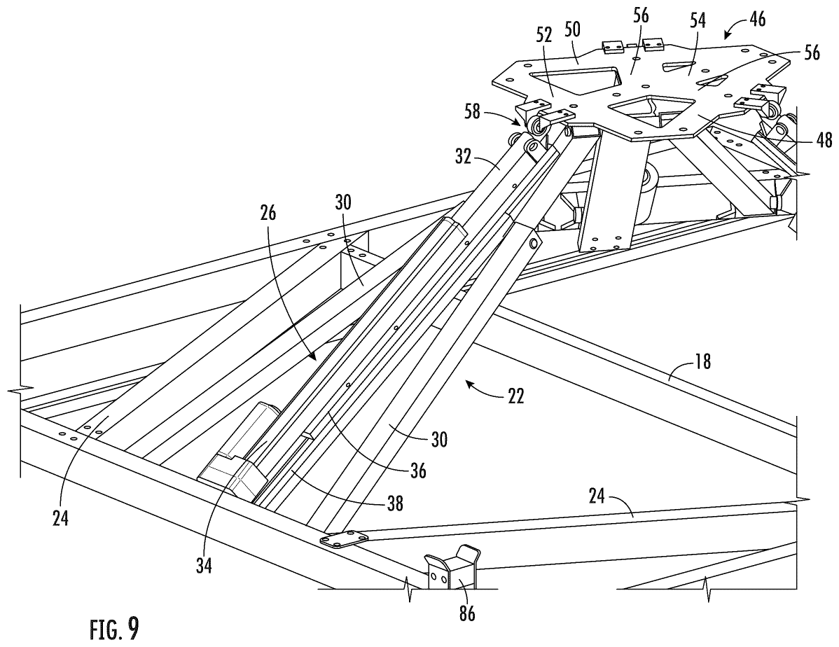

FIG. 10 is a plan view of the actuator;

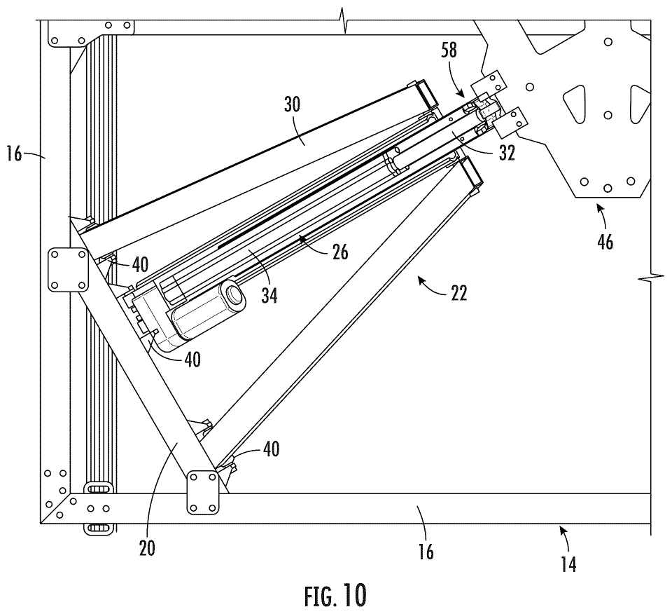

FIG. 11 is an upper perspective view of the device interfaced with support structures common on a vehicle; and

FIG. 12 is a schematic view of electrical components included on the device.

Common reference numerals are used throughout the drawings and the detailed description to indicate the same elements.

### DETAILED DESCRIPTION

The detailed description set forth below in connection with the appended drawings is intended as a description of certain embodiments of an apparatus for mounting a solar panel on a vehicle and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating a preferred embodiment of the present disclosure, and are not for purposes of limiting the same, there is depicted a device 10 for mounting one or more solar panels 12 to a vehicle. The term vehicle, as used herein, refers broadly to any device used for transportation. In this regard, a vehicle may include an automobile, a recreational vehicle (RV), a campervan, a truck, a semi-trailer truck, a boat, etc.

According to one embodiment, the device 10 includes a base frame 14 including four rigid outer frame members 16 coupled to each other to define a quadrangular shape, with each outer frame member 16 being parallel to an opposing outer frame member 16, and perpendicular to two adjacent outer frame members 16. The base frame 14 additionally includes an intermediate frame member 18 extending between two opposing outer frame members 16 from the approximate midpoint of the opposing outer frame members 16. The intermediate frame member 18 also extends in generally spaced parallel relation to the two outer frame members 16.

The base frame 14 additionally includes a pair of corner actuator braces 20, and a pair of corner support trusses 24. The pair of actuator braces 20 extend from a common outer frame member 16 toward a respective adjacent outer frame member 16. In this regard, each actuator brace 20 extends across a respective inner corner of the base frame 14. As will be explained in more detail below, each actuator brace 20 is configured to support a single actuator 22.

The pair of corner support trusses 24 extend from a common outer frame member 16 toward a respective adjacent outer frame member 16. In this regard, each corner support truss 24 extends across a respective inner corner of the base frame 14. The outer frame member 16 from which the pair of corner support trusses 24 extend is opposite the outer frame member 16 from which the pair of actuator braces 20 extend.

The base frame 14 may be configured to be mountable to the vehicle via roof rails 25, a roof rack or via another support system commonly found on vehicles. The base frame 14 may be fabricated from metal or other materials known in the art having the strength needed to support the intended loads, and the physical properties capable of withstanding the environmental elements (e.g., UV, heat, cold, precipitation).

The device 10 includes three actuators 22 coupled to the base frame 14, with the actuators 22 functioning as prismatic joints by selectively extending and retracting relative to the base frame 14. Two actuators 22 are coupled to respective actuator braces 20, and one actuator 22 is coupled to an outer frame member 16 between the pair of corner support trusses 24. Each actuator 22 includes an extender arm 26, a central rail support 28, and a pair of lateral supports 30. The extender arm 26 may include a driven shaft 32 that is extendable from a base 34 between a retracted position and an extended position. The shaft 32 may be driven by a DC motor driver, or alternatively, hydraulically driven, or via other drive mechanisms known in the art. The shaft 32 includes an exposed portion as that portion extending from the base 34. The length of the exposed portion increases as the shaft 32 extends from the retracted position toward the extended position.

The central rail support 28 lies under the extender arm 26 and includes an upper rail 36 and a lower rail 38, with the upper and lower rails 36, 38 being translatable relative to each other. In this regard, the upper and lower rails 36, 38 may include complementary engagement features, such as tongue on one rail that slides within a groove on the other rail. The base 34 of the extender arm 26 may be mounted on the lower rail 38, while a distal end of the shaft 32 may be coupled to the upper rail 36. Thus, the upper rail 36 may move over the lower rail 38 in concert with movement of the shaft 32 relative to the base 34. In other words, the upper rail 36 may move with the shaft 32, while the base 34 and lower rail 38 remain stationary.

The lateral supports 30 may extend on either side of the central rail support 28 to provide lateral support and stability to the central rail support 28. One end portion of the lateral supports 30 may be coupled to the base frame 14, while the other end of the lateral supports 30 may be coupled to the lower rail 38.

Each actuator 22 may be coupled to the base frame 14 via three separate pivot joints; a first pivot joint 40 pivotally connecting a first lateral support 30 to the base frame 14, a second pivot 40 joint pivotally connecting a second lateral support 30 to the base frame 14, and a third pivot joint 40 pivotally connected the central rail support 28 to the base frame 14. The pivot joints 40 allow the actuator 22 to pivot about a single axis 42, which may be associated with the longitudinal direction of the structure to which the actuator 22 is attached. In particular, the pivot axis 42 may be defined by an actuator brace 20 or by the outer frame member 16.

The actuators 22 may be evenly spaced around the device 10, e.g., spaced apart by approximately 120 degrees about a central axis 44. In this regard, the pivot axes 42 associated with the actuators 22 may be offset by approximately 120 degrees, e.g., none of the pivot axes 42 are colinear with each other.

The actuators 22 may be fabricated from metal or other materials known in the art having the strength needed to support the intended loads, and the physical properties capable of withstanding the environmental elements (e.g., UV, heat, cold, precipitation).

The actuators 22 may be coupled to a hub plate 46, which may be generally triangular in shape. The hub plate 46 may include a first side strip 48, a second side strip 50, and a third side strip 52. A central strip 54 may extend from the intersection of the first and second side strips 48, 50 toward the third side strip 52. A pair of angled strips 56 extend from the central strip 54, with one angled strip 56 extending to the first side strip 48 and another angled strip 56 extending to the second side strip 50. The hub plate 46 may include several apertures formed therein to facilitate attachment to a panel support frame, as will be explained in more detail below. The hub plate 46 may be fabricated from metal or other materials known in the art having the strength needed to support the intended loads, and the physical properties capable of withstanding the environmental elements (e.g., UV, heat, cold, precipitation).

The actuators 22 may be coupled to the hub plate 46 via spherical joints 58, and thus, allow for greater relative movement between the hub plate 46 and a given actuator 22. In other words, the hub plate 46 may move relative to a given actuator 22 about at least two axes due to the configuration of the spherical joint 58. According to one embodiment, the spherical joint 58 may include a sphere rotatably retained within a housing, with the sphere being coupled to one of the hub plate 46 or the actuator 22, and the housing being coupled to the other one of the hub plate 46 or the actuator 22. Brackets may be used to connect the spherical joint to the actuator 22 and the hub plate 46.

As mentioned above, the hub plate 46 may be connected to a panel support frame 60, which may include a plurality of outer frame members 62 forming a quadrangular periphery. An intermediate frame member 64 extends between two opposing outer frame members 62 and is attached to the third side strip 52 of the hub plate 46. The intermediate frame member 64 may be parallel to a pair of outer frame members 62 and positioned closer to one of the pair of parallel outer frame members 62 due to the alignment with the third side strip 52 of the hub plate 46. A first set of inner frame members extend from the intermediate frame member toward a common outer frame member 62 extending parallel to the intermediate frame member 64. The first set of inner frame members includes a middle frame member 66 attached to the central strip 54 of the hub plate 46, and a pair of lateral frame members 68 on opposite sides of the middle frame member 66 and spaced from the hub plate 46. A pair of angled support strips 70 may extend from the middle frame member 66 to the intermediate frame member 64, over the first and second side strips 48, 50 of the hub plate 46. A second set of inner frame members 72 may extend from the intermediate frame member 64 toward a common outer frame member 62 extending parallel to the intermediate frame member 64. The second set of inner frame members 72 may include a pair of frame members in spaced relation to each other, extending from the intermediate frame member 64 at a location adjacent and end of the third side strip 52 of the hub plate 46, and approximately at a midpoint along the intermediate frame member 64 between the middle frame member 66 and the lateral frame members 68.

The panel support frame 60 may be capable of being engaged to solar panels 12, such as via screws, rivets, or other mechanical fasteners known in the art. The panel support frame 60 may include a strut channel capable of supporting a variety of different panel dimensions and providing adjustability in the mounting locations of the panels 12. The panel support frame 60 may be fabricated from metal or other materials known in the art having the strength needed to support the intended loads, and the physical properties capable of withstanding the environmental elements (e.g., UV, heat, cold, precipitation).

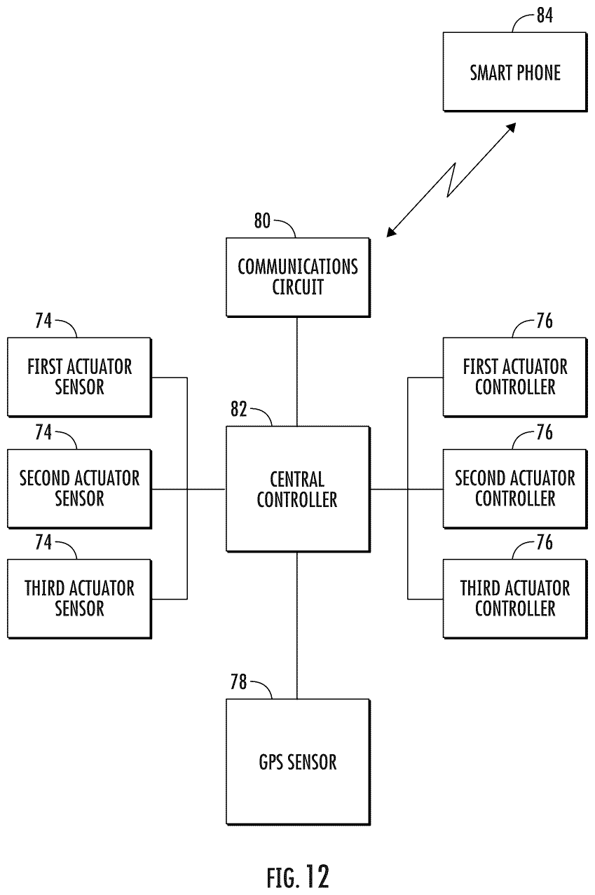

Referring now to FIG. 12, there is depicted an exemplary schematic diagram of electrical components that may be included on the device 10. In particular, the electrical components may include a plurality of actuator sensors 74, a plurality of actuator controllers 76, a GPS sensor 78, a communications circuit 80, and a central controller 82. The actuator sensors 74 may provide position feedback during use of the device 10. In this regard, the length of each actuator 22 may be sensed or otherwise determined to allow for determination of the actual position of the solar panels 12. That position feedback may be used by the central controller 82 to send command signals to the actuator controllers 76, which may be capable of implementing the command signals to transition the actuators 22 to a desired position.

The GPS sensor 78 may be used as an input to the system to calculate the position of the device relative to the sun for purposes of determining an optimal position of the solar panels 12. In this regard, the GPS sensor 78 may be capable of receiving information from one or more satellites to facilitate position calculations. The GPS sensor 78 may also be capable of determining the time of day, local heading angle, as well as the local pitch and roll of the base frame 14.

The communications circuit 80 may allow for two-way communication with a remote device, such as a smartphone 84, computer, etc. Such communications may allow for user control over the device 10, as well as providing the user with real-time information as to the position of the solar panels 12 (e.g., stowed or deployed) as well as the power generated by the solar panels 12. The communications circuit 80 may be capable of communicating via Bluetooth, Wi-Fi, via a cellular communications network, or via other communication modalities known in the art. Various functionalities associated with the device 10 may be implemented via a smartphone app. downloadable on the smartphone 84. In this regard, the smartphone app. may include computer executable instructions which allow for integration of the smartphone with the device 10.

It is also contemplated that the device 10 may include an inertial measurement unit (IMU) in communication with the central controller 82 to detect an orientation of the vehicle. The vehicle orientation may refer to whether the vehicle is parked on a sloped surface or flat surface, and as well as the heading of the vehicle. The orientation data may be used in combination with vehicle position data to calculate a desired position of the solar panel(s).

The device 10 may include other electrical components, such as a user interface (e.g., an LCD display) for displaying data and taking user commands. Such a user interface may be an alternative to, or used in cooperation with, a smartphone. It is also contemplated that the device may include current sensors to measure the amount of electricity generated by the solar panels 12. The device 10 may further include a wind speed sensor and temperature sensor. It is also contemplated that the device 10 may include an accelerometer, connectable to the panel support frame 60, or other portions of the device 10, to detect vibrations of the panels 12. Panel vibrations may be indicative of excessive wind or other conditions which may trigger stowing or retraction of the panels 12. Signal conditioning circuits may also be employed to refine sensor inputs for efficient processing.

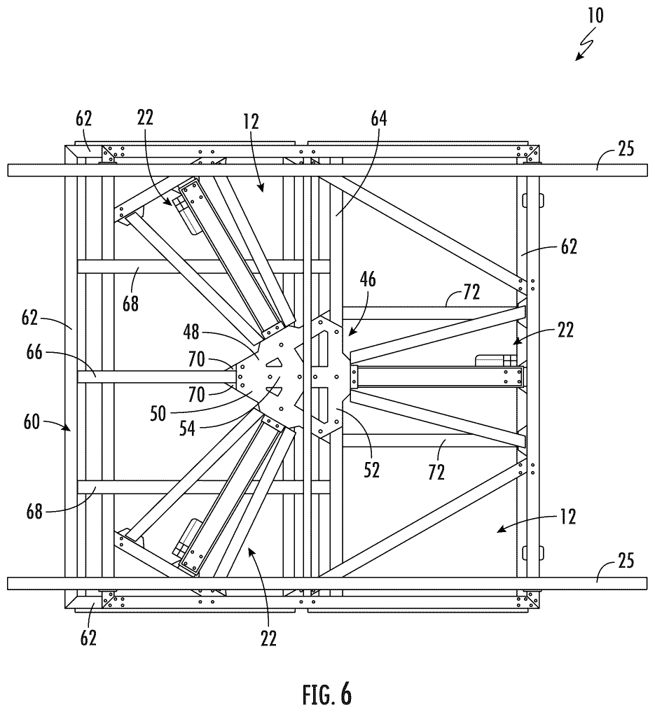

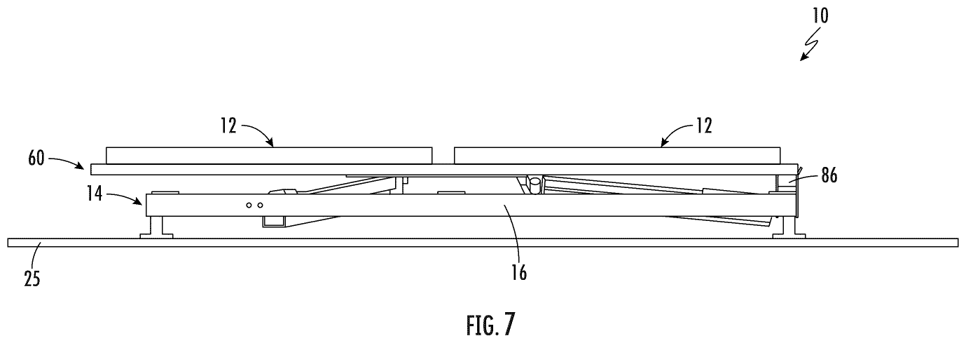

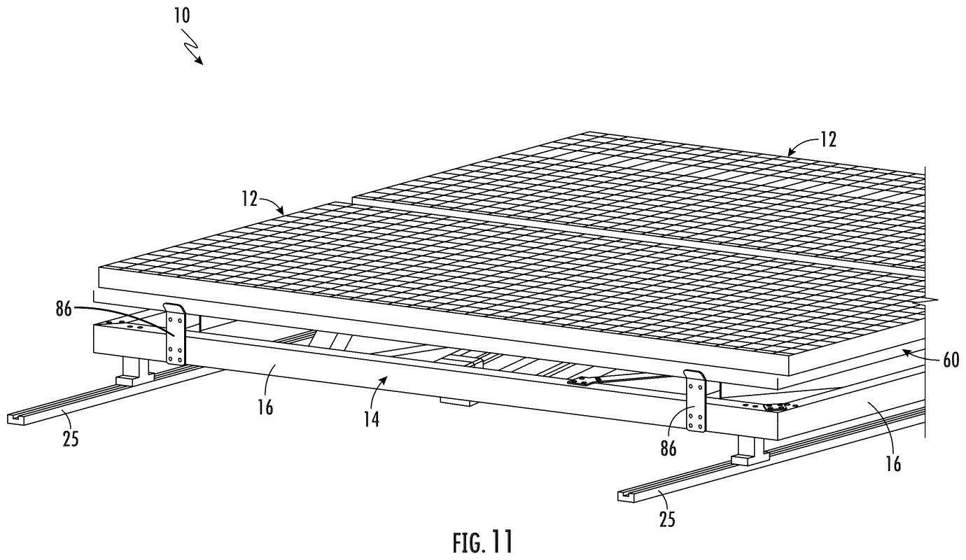

With the basic structure of the device 10 having been described above, the following discussion will focus on use of the device 10. When the vehicle to which the device 10 is mounted is in motion, the device 10 may be in a stowed configuration (e.g., a home configuration), as shown in FIGS. 6, 7, and 11. When in the stowed configuration, the panel support frame 60 may be parallel to the base frame 14, perpendicular to the central axis 44, and may rest on support brackets 86 coupled to the base frame 14. In this stowed configuration, the device 10 defines a very flat, compact profile, which may reduce loads associated with wind.

Once the vehicle is parked, the device 10 may be deployed to an optimal position with the solar panels 12 being perpendicular to the sun. Accordingly, a user may send a command signal, which causes the GPS sensor 78 to gather position data, which may be used to calculate the position of the device 10 as well as the position of the sun, which in turn, allows for a determination of the optimal position of the solar panels 12. Once the optimal position of the solar panels 12 determined, the device 10 will determine the position of each actuator 22 needed to place the solar panels 12 in that position. The actuators 22 will then move to their respective positions associated with the optimized solar panel 12 placement. The spherical joints 58 and the pivoting joints 40 allow the actuators 22 to be raised or lowered as needed during the positional adjustment process. Such raising of one or more actuators 22 and lowering of other actuator(s) 22 facilitates positioning of the solar panels 12 in the optimal position.

The transitioning of the solar panels 12 from their stowed position to the deployed position may be implemented autonomously in response to the user sending the command signal. In this regard, no other input may be required by the user. In certain embodiments, it is contemplated that the device 10 may be in operative communication with the vehicle to deploy the device 10 in response to the vehicle being placed in park, and being turned off. In such implementations, the need for user input may be entirely eliminated.

While the vehicle remains parked, the device 10 may routinely update the optimized panel location based on the constantly changing position of the sun. It is contemplated that the update may occur at any frequency interval, e.g., every minute, every 5 minutes, every ten minutes, etc.

Before the vehicle starts moving again, the device 10 is transitioned from its deployed position to the stowed configuration. This transition may be facilitated by the user entering a command which is recognized by the device 10 to return to the stowed position. However, in one embodiment, the device 10 may include a failsafe mode to automatically transition the device 10 to the stowed configuration in response to movement detected by the GPS sensor 78. For instance, if the GPS sensor 78 detects movement of the vehicle, the central controller 82 may implement a failsafe command, wherein the device 10 automatically returns to the stowed configuration. The device 10 may also be capable of generating an emergency alert in response to detected movement of the vehicle while the device 10 is deployed. Such an alert may be received on the user's smartphone. It is contemplated that the device 10 may also be capable of automatically returning to the stowed configuration in response to environmental events, such as a detected wind speed exceeding a prescribed threshold, as well as the sun setting (e.g., the panels 12 may be stowed from sunset to sunrise).

Although the foregoing discussion focuses on the use of the device 10 on vehicles, it is understood that the scope of the present disclosure is not limited thereto. For instance, it is contemplated that the device 10 may be used on shipping containers, as well as in stationary applications, such as on rooftops, in solar generating fields, etc.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A device for mounting a solar panel on a vehicle and for allowing selective positioning of the solar panel relative to the vehicle, the device comprising:
a base frame;
a first actuator pivotally coupled to the base frame and being transitional relative to the base frame about a first pivot axis between a first retracted position and a first extended position;
a second actuator pivotally coupled to the base frame and being transitional relative to the base frame about a second pivot axis between a second retracted position and a second extended position, the second pivot axis being angularly offset from the first pivot axis;
a third actuator pivotally coupled to the base frame and being transitional relative to the base frame about a third pivot axis between a third retracted position and a third extended position, the third pivot axis being angularly offset from the first and second pivot axes;
a first spherical joint coupled to the first actuator;
a second spherical joint coupled to the second actuator;
a third spherical joint coupled to the third actuator;
a hub coupled to the first actuator via the first spherical joint, the hub being coupled to the second actuator via the second spherical joint, and the hub being coupled to the third actuator by the third spherical joint, the hub being connectable to a solar panel;
each of the first spherical joint, the second spherical joint and the third spherical joint being configured to allow the hub to move relative to the base frame about two axes; and
the hub being selectively positionable relative to the base frame via selective positioning of the first actuator, the second actuator, and the third actuator between their respective retracted and extended positions, and via selective pivoting of the first, second and third actuators relative to the base frame.

2. The device recited in claim 1, further comprising a panel support frame coupled to the hub and configured to facilitate connection between the solar panel and the hub.

3. The device recited in claim 1, wherein each of the first actuator, second actuator, and third actuator includes an extendable portion and a support portion, the extendable portion being moveable relative to the support portion between the respective extended position and retracted position, the extendable portion including a distal end that is moved away from the respective one of the first, second, and third pivot axes as the corresponding actuator moves from the respective retracted position toward the extended position.

4. The device recited in claim 3, wherein each extendable portion includes an extender arm and each support portion includes a pair of lateral supports on opposite sides of the extender arm.

5. The device recited in claim 3, wherein each extender arm includes an upper rail and a lower rail, the upper rail being translatable relative to the lower rail in response to transition of the extendable portion between the extended position and the retracted position.

6. The device recited in claim 5, wherein each support portion is coupled to the lower rail.

7. The device recited in claim 1, wherein the first, second, and third actuators are evenly spaced about a central axis.

8. The device recited in claim 1, further comprising a first actuator sensor for sensing the position of the first actuator being the first retracted position and the first extended position.

9. The device recited in claim 1, further comprising a controller in communication with the first, second, and third actuators, the controller being configured to receive position information associated with the solar panel and facilitate movement of the first, second, and third actuators to transition the solar panel from a current position toward a desired position.

10. The device recited in claim 9, wherein the controller is configured to facilitate movement of the solar panel from the current position toward the desired position autonomously in response to receipt of the position information.

11. A method of selectively positioning a solar panel configured to be attachable to a vehicle, the method comprising the steps of:
receiving position data associated with the solar panel, the solar panel being coupled to a first actuator, a second actuator, and a third actuator, each actuator being pivotally coupled to a base, each actuator having an extendable arm;
calculating an optimal position of the solar panel based on the received position data; and
facilitating transition of the solar panel from a current position toward the optimal position via selective pivotal movement of at least one of the first, second, and third actuators, and movement of at least one extendable arm of the first, second, and third actuators.

12. The method recited in claim 11, wherein the calculating and facilitating steps proceed autonomously in response to receipt of the position data.

13. The method recited in claim 11, further comprising the step of receiving a command signal from the user, the receiving step proceeding in response to receipt of the command signal.

14. The method recited in claim 11, further comprising the step of receiving updated position information a prescribed period of time after transition of the solar panel from the current position toward the optimal position.

15. The method recited in claim 14, further comprising the step of calculating an updated optimal position based on the updated position information.

16. The method recited in claim 15, further comprising the step of facilitating transition of the solar panel from the optimal position toward the updated optimal position via selective pivotal movement of at least one of the first, second and third actuators, and movement of at least one extendable arm of the first, second, and third actuators.

17. The method recited in claim 11, further comprising the steps of receiving orientation data associated with the solar panel and calculating the optimal position of the solar panel based on a combined assessment of the received position data and orientation data.

18. A device for mounting a solar panel on a structure and for allowing selective positioning of the solar panel relative to the structure, the device comprising:
a base frame attachable to the structure;
a first actuator pivotally coupled to the base frame and being transitional relative to the base frame about a first pivot axis between a first retracted position and a first extended position;
a second actuator pivotally coupled to the base frame and being transitional relative to the base frame about a second pivot axis between a second retracted position and a second extended position, the second pivot axis being angularly offset from the first pivot axis;
a third actuator pivotally coupled to the base frame and being transitional relative to the base frame about a third pivot axis between a third retracted position and a third extended position, the third pivot axis being angularly offset from the first and second pivot axes;
a hub coupled to the first actuator, the second actuator, and the third actuator in a manner such that the hub is pivotable relative to each actuator about two axes, the hub being connectable to a solar panel; and
the hub being selectively positionable relative to the base frame via selective positioning of the first actuator, the second actuator, and the third actuator between their respective retracted and extended positions, and via selective pivoting of the first, second and third actuators relative to the base frame.

19. The device recited in claim 18, wherein each of the first actuator, second actuator, and third actuator includes an extendable portion and a support portion, the extendable portion being moveable relative to the support portion between the extended position and the retracted position, the extendable portion including a distal end that is moved away from the respective one of the first, second, and third pivot axes as the corresponding actuator transitions from the retracted position toward the extended position.

20. The device recited in claim 19, wherein each extendable portion further includes an extender arm including an upper rail and a lower rail, the upper rail being translatable relative to the lower rail in response to transition of the extendable portion between the extended position and the retracted position.
